(19) United States
(12) Patent Application Publication
(10) Pub. No.: US 2026/0123792 A1
(43) Pub. Date: May 7, 2026

(54) BOOSTED OUTPUT GAS BURNERS FOR GAS-FUELED OUTDOOR COOKING APPLIANCES

(71) Applicant: Weber-Stephen Products LLC, Palatine, IL (US)

(72) Inventors: Sebastian Szulakiewicz, Mount Prospect, IL (US); Robert J. Farmer, Naperville, IL (US); Lance G. Velez, Chicago, IL (US); John R. Ciccone, Barrington, IL (US); Paul R. Hunt, Lake Zurich, IL (US); Mohammed Shoeb, Hoffman Estates, IL (US)

(21) Appl. No.: 18/940,212

(22) Filed: Nov. 7, 2024

(51) Int. Cl. A47J 37/07

(52) U.S. Cl. CPC A47J 37/0713

(57) ABSTRACT

Boosted output gas burners for gas-fueled outdoor cooking appliances are disclosed. An example gas burner includes a housing and a tube. The housing includes a bottom wall, a front wall, a rear wall, a right sidewall, a left sidewall, and a top wall. The front wall includes an opening. The top wall includes first ports arranged in a first row and second ports arranged in a second row spaced apart from the first row. The tube is located at least partially within the housing. The tube extends through the opening of the front wall. The tube includes an inlet portion, a venturi portion located downstream from the inlet portion, and a mixing portion located downstream from the venturi portion. The inlet portion includes an open front end located externally from the housing. The mixing portion includes an open rear end located within the housing forward of the rear wall.

### FIELD OF THE DISCLOSURE

This disclosure relates generally to gas burners and, more specifically, to boosted output gas burners for gas-fueled outdoor cooking appliances.

### BACKGROUND

Cookboxes of conventional gas-fueled outdoor cooking appliances (e.g., gas grills, gas griddles, etc.) are typically equipped with two or more atmospheric burners (e.g., burners that operate at atmospheric pressure and without forced induction) that are spaced apart from one another (e.g., a right burner and a left burner) and configured to provide zone-based heating within the cookbox. Atmospheric burners have existed for over one hundred years, and their use in gas-fueled outdoor cooking appliances is widely accepted.

For any given atmospheric burner design, there are natural limits to the “low” and the “high” operating settings. The “low” setting (e.g., the lowest flow rate at which a combustible gas-air mixture travels through the burner) is limited by the burner's ability to prevent flashback. The “high” setting (e.g., the highest flow rate at which a combustible gas-air mixture travels through the burner) is limited by the burner's ability to prevent flame lift and/or combustion outputs (e.g., non-combusted carbon, carbon monoxide content in exhaust). Thus, the low-energy setting and the high-energy setting of any given burner is set such that the individual burner, and the complete system of burners within the gas-fueled outdoor cooking appliance, operate within safe conditions.

For example, an individual burner of a Weber® Genesis II 310 model gas grill operates between a low setting of six thousand British Thermal Units per hour (6,000 BTU/hour) and a high setting of thirteen thousand five hundred British Thermal Units per hour (13,500 BTU/hour). The ratio between the high operational setting and the low operational setting of a burner is known as the “turndown ratio.” In the above example, the individual burner of the Weber® Genesis II 310 model has a turndown ratio of 2.25, calculated by dividing the high operational setting (13,500 BTU/hour) by the low operational setting (6,000 BTU/hour).

When designing a burner for a gas-fueled outdoor cooking appliance, it is generally desirable to maximize the turndown ratio of the burner. Efforts to maximize the turndown ratio are typically bounded, however, by the above-described natural limits (e.g., the burner's ability to prevent flashback, and the burner's ability to prevent flame lift and/or combustion outputs), and/or by other design constraints.

### BRIEF DESCRIPTION OF THE DRAWINGS

FIG. 1 is a perspective view of an example gas burner constructed in accordance with teachings of this disclosure.

FIG. 2 is a top view of the gas burner of FIG. 1.

FIG. 3 is a bottom view of the gas burner of FIGS. 1 and 2.

FIG. 4 is a right side view of the gas burner of FIGS. 1-3.

FIG. 5 is a left side view of the gas burner of FIGS. 1-4.

FIG. 6 is a cross-sectional view of the gas burner of FIGS. 1-5 taken along section A-A of FIG. 2.

FIG. 7 is a cross-sectional view of the gas burner of FIGS. 1-6 taken along section B-B of FIG. 4.

FIG. 8 is a cross-sectional view of the gas burner of FIGS. 1-7 taken along section C-C of FIG. 2.

FIG. 9 is a perspective view of the gas burner of FIGS. 1-8, with the housing of the gas burner shown in phantom.

FIG. 10 is a first isolated perspective view of the tube of the gas burner of FIGS. 1-9.

FIG. 11 is a second isolated perspective view of the tube of the gas burner of FIGS. 1-9.

FIG. 12 is a perspective view of an example gas burner assembly constructed in accordance with the teachings of this disclosure.

FIG. 13 is a rear perspective view of the gas burner assembly of FIG. 12.

FIG. 14 is a perspective view of an example cookbox assembly including the gas burner assembly of FIGS. 12 and 13.

FIG. 15 is a top view of the cookbox assembly of FIG. 14.

FIG. 16 is a top view of the cookbox assembly of FIGS. 14 and 15, with the cooking grate(s) removed from the cookbox assembly.

FIG. 17 is a top view of the cookbox assembly of FIGS. 14-16, with the cooking grate(s) and the grease deflection bar(s) removed from the cookbox assembly.

FIG. 18 is a cross-sectional view of the cookbox assembly of FIGS. 14-17 taken along section D-D of FIG. 15.

FIG. 19 is a perspective cross-sectional view of the cookbox assembly of FIGS. 14-18 taken along section D-D of FIG. 15.

FIG. 20 is a cross-sectional view of the cookbox assembly of FIGS. 14-19 taken along section E-E of FIG. 15.

FIG. 21 is a perspective cross-sectional view of the cookbox assembly of FIGS. 14-20 taken along section E-E of FIG. 15.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Example boosted output gas burners disclosed herein provide significant improvements with regard to the maximum heat output, the operational range, and the associated turndown ratio that are attainable from such boosted output gas burners relative to the maximum heat output, the operational range, and the associated turndown ratio that are attainable via conventional atmospheric gas burners of an equivalent size. In some examples, boosted output gas burners disclosed herein are configured to operate with a low heat output of approximately 6,000 BTU/hour and a high heat output of approximately 18,000 BTU/hour, thereby providing an operational heating range of approximately 12,000 BTU/hour (e.g., 18,000−6,000=12,000), and a turndown ratio of approximately 3.00 (e.g., 18,000/6,000=3.00). By contrast, a known burner of the Weber® Genesis II 310 model gas grill operates with a low heat output of approximately 6,000 BTU/hour and a high heat output of approximately 13,500 BTU/hour, thereby providing an operational heating range of approximately 7,500 BTU/hour (e.g., 13,500−6,000=7,500), and a turndown ratio of approximately 2.25 (e.g., 13,500/6,000=2.25). Such improvements with regard to the maximum heat output, the operational range, and the associated turndown ratio attributed to the disclosed boosted output gas burners provide numerous advantages to gas-fueled outdoor cooking appliances and the user experience associated therewith. For example, the higher energy levels (e.g., maximum heat outputs) achievable via the disclosed boosted output gas burners significantly reduce the time needed to preheat a cooking chamber of the gas-fueled outdoor cooking appliance and/or to cook (e.g., sear) items of food located therein. As another example, when multiple instances of the disclosed boosted output gas burners are implemented within a gas-fueled outdoor cooking appliance, the higher energy levels achievable via the disclosed boosted output gas burners enable the entire cooking surface of the gas grill to be used for high-heat searing.

In some disclosed examples, a gas burner includes a housing and a tube. The housing includes a bottom wall, a front wall, a rear wall, a right sidewall, a left sidewall, and a top wall. The front wall includes an opening. The top wall includes a plurality of first ports arranged in a first row and a plurality of second ports arranged in a second row spaced apart from the first row. The tube is located at least partially within the housing. The tube extends through the opening of the front wall of the housing. The tube includes an inlet portion, a venturi portion in fluid communication with and located downstream from the inlet portion, and a mixing portion in fluid communication with and located downstream from the venturi portion. The inlet portion includes an open front end located externally from the housing. The mixing portion including an open rear end located within the housing and spaced forward of the rear wall of the housing. The tube is configured to carry a combustible gas-air mixture from the inlet portion into and through the venturi portion and from the venturi portion into and through the mixing portion. Upon exiting the open rear end of the mixing portion, the combustible gas-air mixture is directed forward within the housing to respective ones of the first ports and respective ones of the second ports.

In some disclosed examples, the open rear end of the mixing portion of the tube is spaced forward of the rear wall of the housing by a preferred distance that is greater than 5.0 millimeters and less than 20.0 millimeters. In some disclosed examples, the second row of the second ports is spaced apart from the first row of the first ports by a preferred distance that is greater than 2.0 centimeters and less than 5.0 centimeters. Such features of the disclosed boosted output gas burners advantageously facilitate the above-described improvements with regard to the maximum heat output, the operational range, and the associated turndown ratio of such gas burners while also minimizing (e.g., preventing) erratic flame behavior such as flashback, flame lift, and/or flame bunching. Furthermore, forcing the combustible gas-air mixture to travel the entire length of the mixing portion of the tube before the combustible gas-air mixture is able to reach the first ports and/or the second ports formed in the top wall of the housing advantageously reduces the velocity of the combustible gas-air mixture, advantageously enables the gas and the air components that contribute to the combustible gas-air mixture to better mix with one another, and advantageously provides better control over the velocity of the combustible gas-air mixture at it reaches the first ports and the second ports.

The above-identified features as well as other advantageous features of example boosted output gas burners for gas-fueled outdoor cooking appliances as disclosed herein are further described below in connection with the figures of the application.

As used herein, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts at the point (or points) of contact between the two parts.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein in the context of describing the relationship between two structures, the terms “in fluid communication,” “fluidically connected,” and/or “fluidically coupled” mean that the two structures are individually and/or collectively configured to allow a fluid (e.g., a gas or a liquid) to pass (e.g., to flow) from the first of the two structures to the second of the two structures, or vice-versa. For example, a second flow channel may be described as being in fluid communication with a first flow channel when a fluid (e.g., a gas or a liquid) is able to pass (e.g., to flow) from the first flow channel into the second flow channel, or from the second flow channel into the first flow channel.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

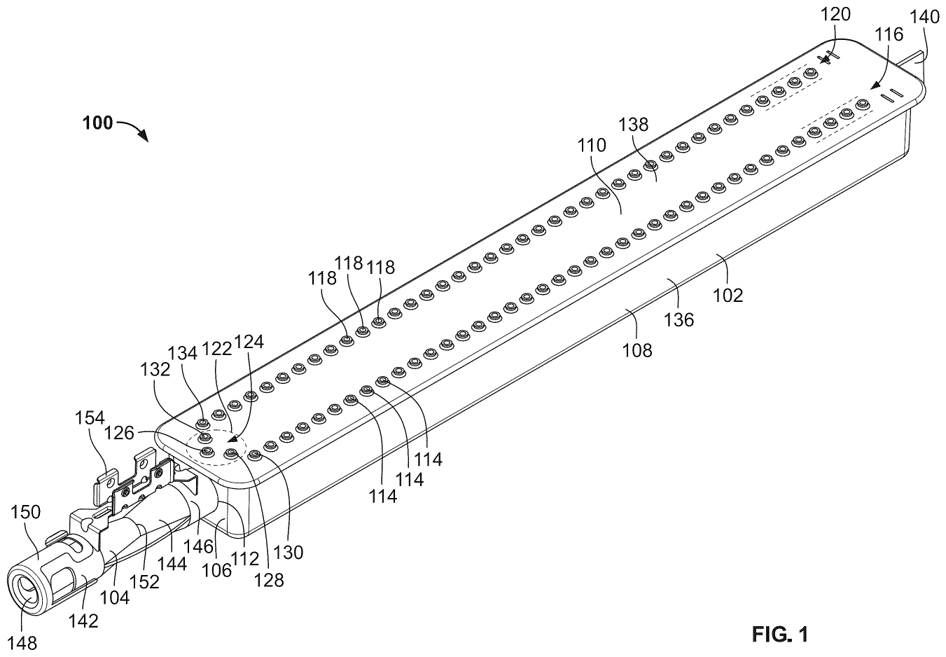

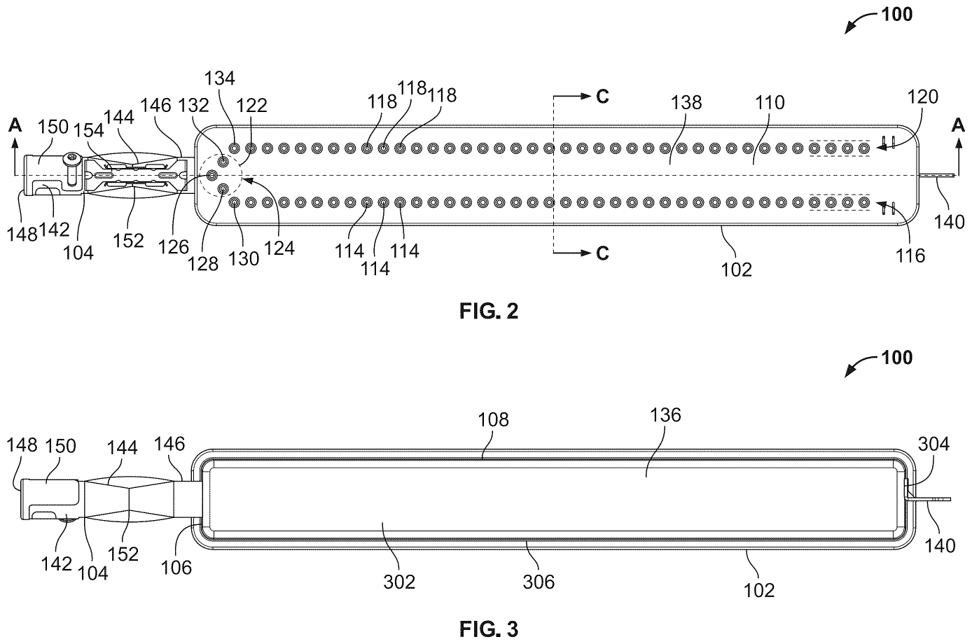

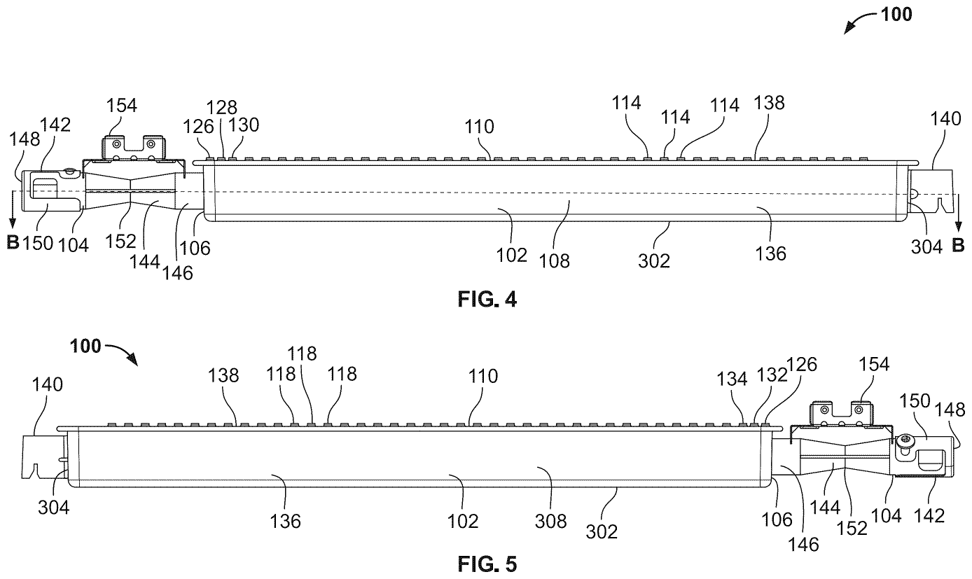

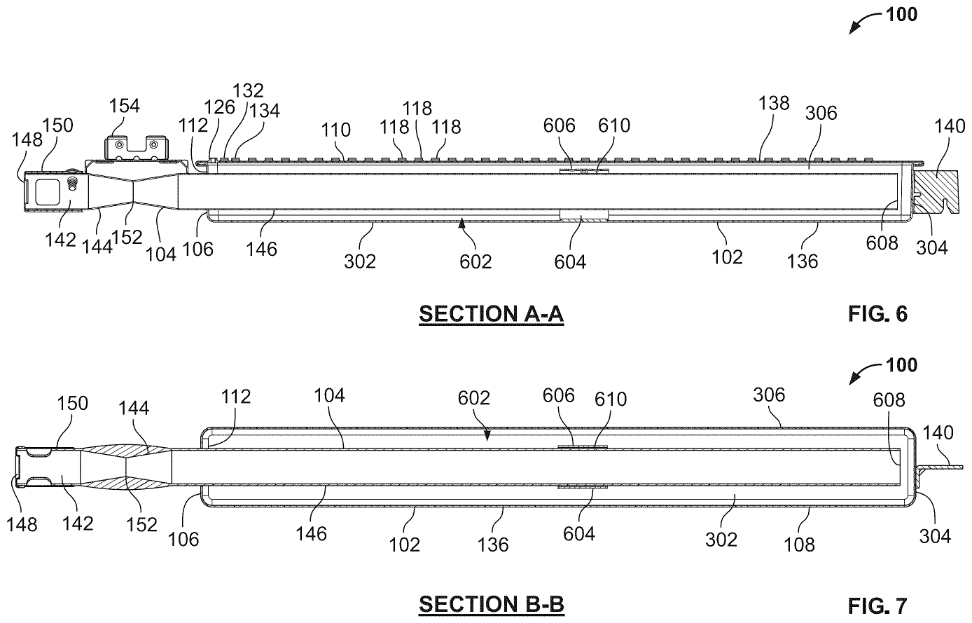

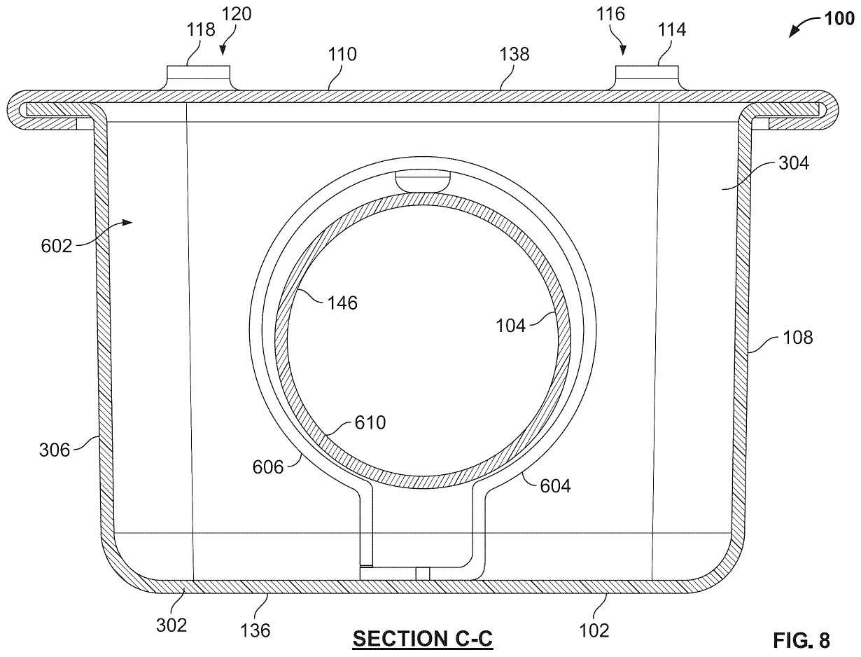

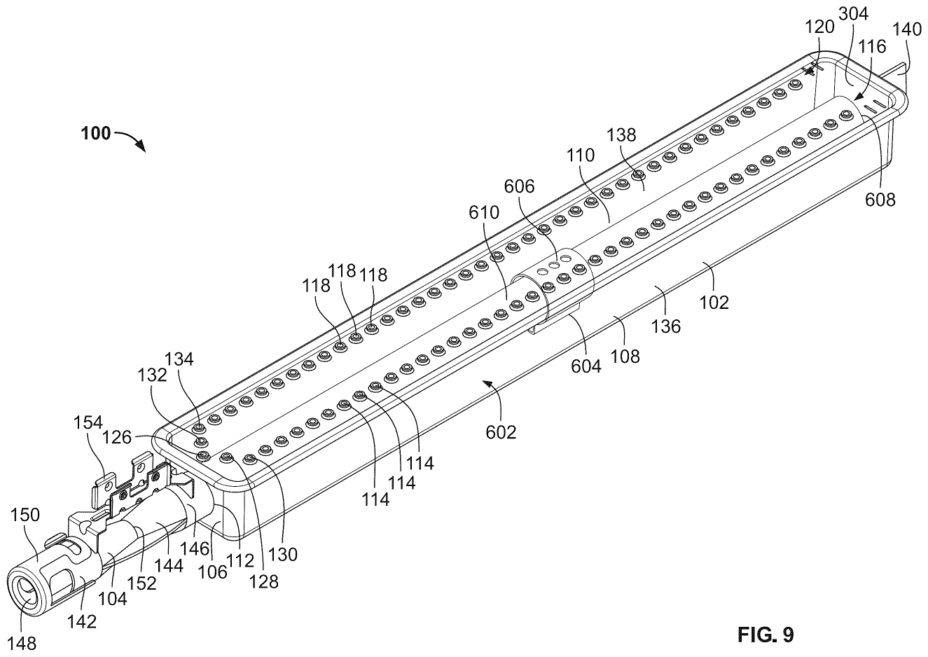

FIG. 1 is a perspective view of an example gas burner 100 constructed in accordance with teachings of this disclosure. FIG. 2 is a top view of the gas burner 100 of FIG. 1. FIG. 3 is a bottom view of the gas burner 100 of FIGS. 1 and 2. FIG. 4 is a right side view of the gas burner 100 of FIGS. 1-3. FIG. 5 is a left side view of the gas burner 100 of FIGS. 1-4. FIG. 6 is a cross-sectional view of the gas burner 100 of FIGS. 1-5 taken along section A-A of FIG. 2. FIG. 7 is a cross-sectional view of the gas burner 100 of FIGS. 1-6 taken along section B-B of FIG. 4. FIG. 8 is a cross-sectional view of the gas burner 100 of FIGS. 1-7 taken along section C-C of FIG. 2.

The gas burner 100 of FIG. 1-8 includes an example housing 102 and an example tube 104. In the illustrated example of FIGS. 1-8, the housing 102 is a box-shaped structure having a generally rectangular cross-sectional area along a length of the housing 102, and the tube 104 is a cylindrical structure having a generally circular cross-sectional area along a length of the tube 104. In other examples, the shape of the housing 102 and/or the shape of the tube 104 can differ from the shape shown in FIGS. 1-8. For example, the tube 104 can instead be implemented as a box-shaped structure having a generally rectangular cross-sectional area along a length of the tube 104. FIG. 9 is a perspective view of the gas burner 100 of FIGS. 1-8, with the housing 102 of the gas burner 100 shown in phantom. The gas burner 100 of FIGS. 1-9 is configured such that a portion of the tube 104 of the gas burner 100 extends into and/or is located within a chamber formed by the housing 102 of the gas burner 100, as further described herein.

The housing 102 of the gas burner 100 of FIGS. 1-9 includes an example bottom wall 302, an example front wall 106, an example rear wall 304, an example right sidewall 108, an example left sidewall 306, and an example top wall 110. In the illustrated example of FIGS. 1-9, the rear wall 304 of the housing 102 is spaced apart from the front wall 106 of the housing 102, the right sidewall 108 of the housing 102 extends between the front wall 106 and the rear wall 304 of the housing 102, and the left sidewall 306 of the housing 102 is spaced apart from the right sidewall 108 of the housing 102 and extends between the front wall 106 and the rear wall 304 of the housing 102. As further shown in FIGS. 1-9, the front wall 106, the rear wall 304, the right sidewall 108, and the left sidewall 306 of the housing 102 each extend upwardly from the bottom wall 302 of the housing 102. The top wall 110 of the housing 102 is spaced apart from the bottom wall 302 of the housing 102, with the top wall 110 extending between the front wall 106 and the rear wall 304 of the housing 102, and also extending between the right sidewall 108 and the left sidewall 306 of the housing 102.

The front wall 106 of the housing 102 of FIGS. 1-9 includes an example opening 112 configured to receive a portion of the tube 104. In the illustrated example of FIGS. 1-9, the opening 112 has a circular shape that matches and/or complements the circular cross-sectional area of the tube 104. In other examples, the opening 112 can instead have a different shape (e.g., a rectangular shape) that matches and/or complements a correspondingly different shaped cross-sectional area (e.g., a rectangular cross-sectional area) of the tube 104 (e.g., when the tube 104 is implemented as a box-shaped structure having a generally rectangular cross-sectional area along a length of the tube 104).

The top wall 110 of the housing 102 of FIGS. 1-9 includes a plurality of example first ports 114 arranged in an example first row 116, and a plurality of example second ports 118 arranged in an example second row 120 spaced apart from the first row 116. The first row 116 of the first ports 114 and the second row 120 of the second ports 118 are linear rows that respectively extend along the length of the top wall 110 and/or, more generally, along the length of the housing 102. In the illustrated example of FIGS. 1-9, the second row 120 of the second ports 118 is parallel to the first row 116 of the first ports 114. The second row 120 of the second ports 118 is preferably spaced apart from the first row 116 of the first ports 114 by a distance that is greater than 2.0 centimeters and less than 5.0 centimeters. For example, in the illustrated example of FIGS. 1-9, the second row 120 of the second ports 118 is spaced apart from the first row 116 of the first ports 114 by a distance of approximately 2.8 centimeters. In other examples, the second row 120 of the second ports 118 can instead be spaced apart from the first row 116 of the first ports 114 by a distance that is less than 2.0 centimeters. In still other examples, the second row 120 of the second ports 118 can instead be spaced apart from the first row 116 of the first ports 114 by a distance that is greater than 5.0 centimeters. In the illustrated example of FIGS. 1-9, the first ports 114 and the second ports 118 respectively include approximately forty ports in their corresponding rows (e.g., approximately forty first ports 114 in the first row 116, and approximately forty second ports 118 in the second row 120). In other examples, the first ports 114 and/or the second ports 118 can instead include substantially more than forty ports (e.g., fifty ports, seventy-five ports, one hundred ports, etc.) in their corresponding rows. In still other examples, the first ports 114 and/or the second ports 118 can instead include substantially less than forty ports (e.g., ten ports, twenty-five ports, thirty ports, etc.) in their corresponding rows.

The top wall 110 of the housing 102 of FIGS. 1-9 further includes one or more example third port(s) 122 located proximate the front wall 106 of the housing 102 between the first row 116 of the first ports 114 and the second row 120 of the second ports 118. The third port(s) 122 is/are configured to facilitate ignition of a combustible gas-air mixture traveling through the housing 102 via an ignitor located externally from the housing 102 proximate at least one of the third port(s) 122. The third port(s) 122 is/are further configured to facilitate spreading (e.g., dispersion) of the ignition of the combustible gas-air mixture to the first row 116 of the first ports 114 and to the second row 120 of the second ports 118.

As shown in the illustrated example of FIGS. 1-9, the third port(s) 122 preferably include and/or are preferably implemented by at least three ports arranged in an example V-shaped formation 124 that includes an example central port 126, at least one example first branch port 128 located between the central port 126 and an example front one 130 of the first ports 114 of the first row 116, and at least one example second branch port 132 located between the central port 126 and an example front one 134 of the second ports 118 of the second row 120. In other examples, the third port(s) 122 can instead be implemented by a single port (e.g., the central port 126) located proximate the front wall 106 of the housing 102 between the first row 116 of the first ports 114 and the second row 120 of the second ports 118, with the single port being located proximate the front one 130 of the first ports 114 of the first row 116 and proximate the first one 134 of the second ports 118 of the second row 120.

The diameter of each one of the first ports 114, each one of the second ports 118, and each one of the third port(s) 122 is preferably greater than 1.8 millimeters and less than 3.0 millimeters. For example, in the illustrated example of FIGS. 1-9, the diameter of each one of the first ports 114, each one of the second ports 118, and each one of the third port(s) 122 is approximately 2.4 millimeters. In other examples, one or more of the first ports 114, one or more of the second ports 118, and/or one or more of the third port(s) 122 can include a diameter that is less than 1.8 millimeters. In still other examples, one or more of the first ports 114, one or more of the second ports 118, and/or one or more of the third port(s) 122 can include a diameter that is greater than 3.0 millimeters. In the illustrated example of FIGS. 1-9, the first ports 114, the second ports 118, and the third port(s) 122 are respectively implemented by and/or as raised ports that extend upwardly from a surrounding planar surface of the top wall 110 of the housing 102. Such raised ports can be formed, for example, by an extrusion process applied to the top wall 110 of the housing 102 during the fabrication thereof in conjunction with forming the first ports 114, the second ports 118, and/or the third port(s) 122 of the top wall 110. In other examples, the first ports 114, the second ports 118, and/or the third port(s) 122 can instead be implemented in a manner that results in the first ports 114, the second ports 118, and/or the third port(s) 122 being flush (e.g., co-planar) with and/or relative to a surrounding planar surface of the top wall 110 of the housing 102.

Aside from the opening 112 formed in the front wall 106 of the housing 102 and the ports (e.g., the first ports 114, the second ports 118, and the third port(s) 122) formed in the top wall 110 of the housing 102 as described above, the housing 102 is otherwise preferably free of openings and/or ports. In this regard, the bottom wall 302, the rear wall 304, the right sidewall 108, and the left sidewall 306 of the housing 102 are preferably formed as solid walls that do not include any openings and/or ports of the type described above in connection with the front wall 106 and the top wall 110 of the housing 102. In the illustrated example of FIGS. 1-9, the front wall 106, the rear wall 304, the right sidewall 108, and the left sidewall 306 of the housing 102 are integrally formed with the bottom wall 302 of the housing 102 to provide an example base 136. The top wall 110 of the housing 102 provides an example cover 138 for the base 136. In the illustrated example of FIGS. 1-9, the cover 138 is securely coupled to the base 136. For example, an edge of the cover 138 can be crimped to an edge of the base 136. As another example, a portion of the cover 138 can be welded to a portion of the base 136. The coupling of the cover 138 to the base 136 is preferably implemented in a manner that seals any junctions and/or joints formed between the cover 138 and the base 136. As a result of such sealing, a combustible gas-air mixture traveling through the housing 102 is led (e.g., directed or forced) to escape the housing 102 via the first ports 114, the second ports 118, and/or the third port(s) 122 formed in the top wall 110 of the housing 102, as opposed to such air-gas mixture instead being able to leak out of one or more junction(s) and/or joint(s) formed between the cover 138 and the base 136.

In the illustrated example of FIGS. 1-9, the bottom wall 302, the front wall 106, the rear wall 304, the right sidewall 108, the left sidewall 306, and the top wall 110 of the housing 102 form and/or provide an example chamber 602 located within the housing 102. The chamber 602 of the housing 102 is configured to house and/or contain a portion of the tube 104 of the gas burner 100, as further described herein. The chamber 602 is further configured to house and/or contain a combustible gas-air mixture that enters the chamber 602 via an outlet of the tube 104 of the gas burner 100, and which thereafter exits the chamber 602 via the first ports 114, the second ports 118, and/or the third port(s) 122 formed in the top wall 110 of the housing 102. In the illustrated example of FIGS. 1-9, the chamber 602 of the housing 102 has a generally rectangular cross-sectional area along a length of the housing 102. In other examples, the shape of the chamber 602 of the housing 102 can differ from the shape shown in FIGS. 1-9.

As shown in FIGS. 6-9, the housing 102 and/or, more generally, the gas burner 100 of FIGS. 1-9 further includes an example support bracket 604 located within the chamber 602 of the housing 102 and configured to support a portion of the tube 104 within the chamber 602 of the housing 102. The support bracket 604 is preferably configured to include an example contoured portion 606 (e.g., a curved or arc-shaped portion) that matches and/or complements a contoured area (e.g., a curved or arc-shaped area) of the portion of the tube 104 that is supported by the support bracket 604. In the illustrated example of FIGS. 1-9, the support bracket 604 is located within the chamber 602 approximately midway between the front wall 106 and the rear wall 304 of the housing 102 and approximately midway between the right sidewall 108 and the left sidewall 306 of the housing 102. In other examples, the location of the support bracket 604 within the chamber 602 of the housing 102 can instead be skewed closer to either the front wall 106 or the rear wall 304 of the housing 102, and/or closer to either the right sidewall 108 or the left sidewall 306 of the housing 102. In the illustrated example of FIGS. 1-9, the support bracket 604 is coupled to and extends upwardly from the bottom wall 302 of the housing 102. In other examples, the support bracket 604 can instead be coupled to and extend downwardly from the top wall 110 of the housing 102. In still other examples, the support bracket 604 can instead be coupled to and extend laterally (e.g., sideways) from either the right sidewall 108 or the left sidewall 306 of the housing 102.

The housing 102 and/or, more generally, the gas burner 100 of FIGS. 1-9 further includes an example mounting flange 140 configured to couple the housing 102 and/or, more generally, the gas burner 100 to a portion (e.g., a rear wall, a rear trim panel, etc.) of a cookbox of a gas-fueled outdoor cooking appliance (e.g., a gas grill), as further described herein. In the illustrated example of FIGS. 1-9, the mounting flange 140 is coupled to and extends rearwardly from the rear wall 304 of the housing 102, with the mounting flange 140 being located approximately midway between the right sidewall 108 and the left sidewall 306 of the housing 102. In other examples, the mounting flange 140 can instead be coupled to the bottom wall 302, the right sidewall 108, the left sidewall 306, and/or the top wall 110 of the housing 102 of the gas burner 100. In some examples, the mounting flange 140 is integrally formed with a portion of the housing 102 of the gas burner 100. For example, the mounting flange 140 can be integrally formed with the rear wall 304 of the housing 102.

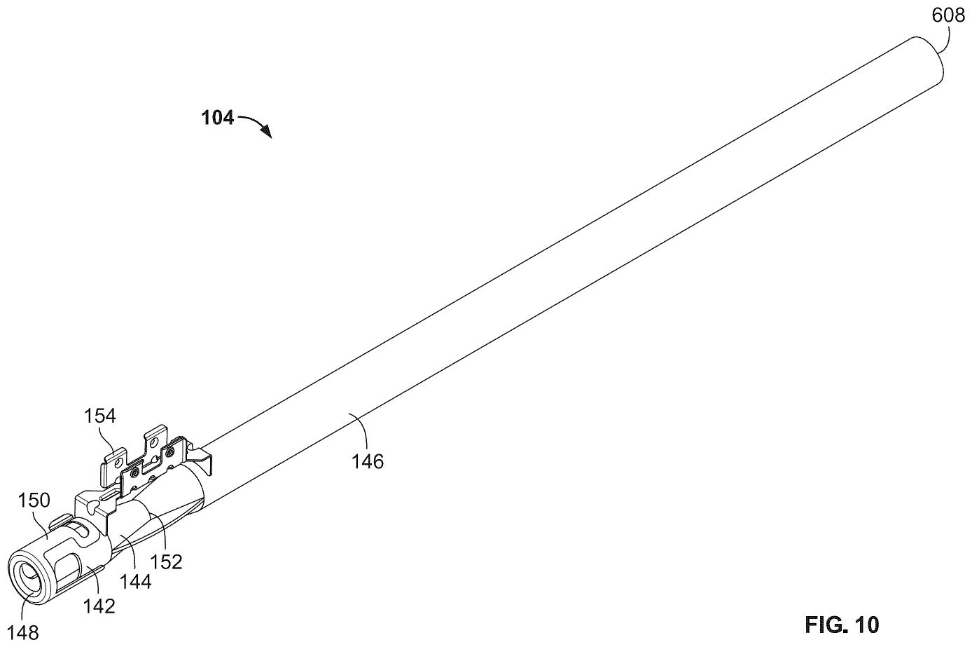

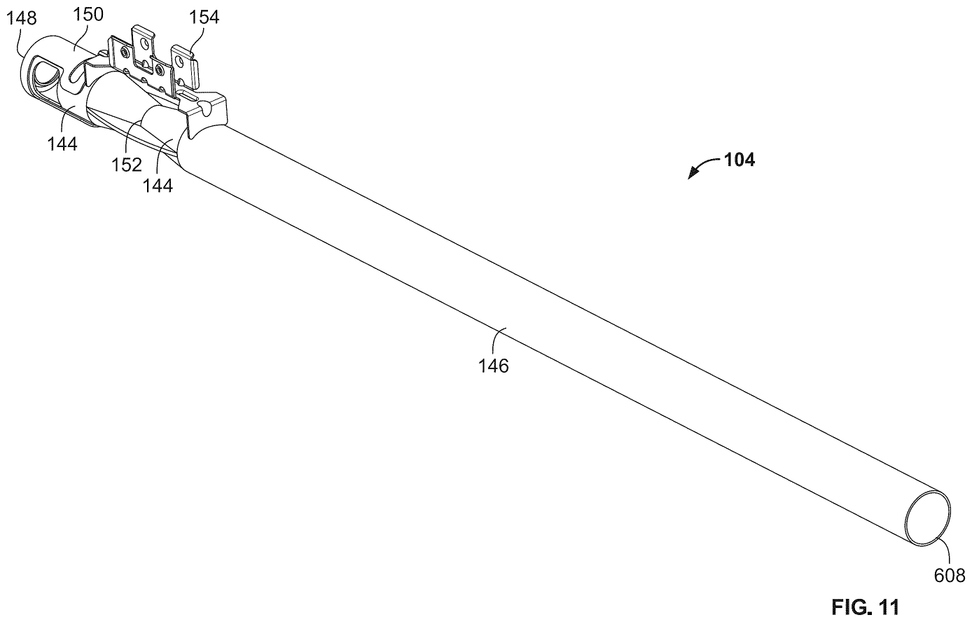

As discussed above, the tube 104 of the gas burner 100 of FIGS. 1-9 is configured to be at least partially disposed within the chamber 602 of the housing 102, with a portion of the tube 104 extending through the opening 112 formed in the front wall 106 of the housing 102. FIG. 10 is a first isolated perspective view of the tube 104 of the gas burner 100 of FIGS. 1-9. FIG. 11 is a second isolated perspective view of the tube 104 of the gas burner 100 of FIGS. 1-9. The tube 104 of FIGS. 1-11 includes an example inlet portion 142, an example venturi portion 144 in fluid communication with and located downstream from the inlet portion 142, and an example mixing portion 146 in fluid communication with and located downstream from the venturi portion 144. In the illustrated example of FIGS. 1-9, at least a portion of the mixing portion 146 of the tube 104 is located within the chamber 602 of the housing 102, while the inlet portion 142 and the venturi portion 144 of the tube 104 are respectively located externally from the housing 102. For example, as shown in FIGS. 1-9, the entirety of the venturi portion 144 of the tube 104 is located externally from the housing 102 at a position forward of the front wall 106 of the housing 102, and the entirety of the inlet portion 142 of the tube 104 is located externally from the housing 102 at a position forward of the front wall of the housing 102 and/or forward of the venturi portion 144 of the tube 104. In other examples, at least a portion of the venturi portion 144 of the tube 104 can instead be located within the chamber 602 of the housing 102, along with the entirety of the mixing portion 146 of the tube 104. In still other examples, at least some portion of the inlet portion 142 of the tube 104 can instead be located within the chamber 602 of the housing 102, along with the entirety of the venturi portion 144 and the entirety of the mixing portion 146 of the tube 104.

The inlet portion 142 of the tube 104 of FIGS. 1-11 includes an example open front end 148 located externally from the housing 102. For example, as shown in FIGS. 1-9, the open front end 148 of the inlet portion 142 of the tube 104 is located externally from the housing 102 at a position forward of the front wall 106 of the housing 102. The open front end 148 of the inlet portion 142 of the tube 104 is configured to receive an outlet nozzle of a gas valve, as further discussed herein. As shown in FIGS. 1-11, the tube 104 and/or, more generally the gas burner 100 further includes an example air shutter 150 coupled to the inlet portion 142 of the tube 104, with the air shutter 150 being adjustable (e.g., rotatable) relative to the inlet portion 142 of the tube 104 to facilitate adjustment of an amount of air (e.g., forming part of a gas to air ratio associated with a combustible gas-air mixture) that enters the inlet portion 142 of the tube 104 via an opening formed in a sidewall of the inlet portion 142 of the tube 104, as is well known in the art.

In the illustrated example of FIGS. 1-11, the diameter of the circular cross-sectional area of the tube 104 generally remains constant along the length of the tube 104 with the exception of the venturi portion 144 thereof. In this regard, the venturi portion 144 of the tube 104 has a circular cross-sectional area that gradually decreases (e.g., thereby constricting and/or narrowing the flow path of the combustible gas-air mixture) along the length of the tube 104 beginning at the end of the inlet portion 142 of the tube 104 and continuing to an example midpoint 152 of the venturi portion 144. The circular cross-sectional area of the venturi portion 144 then gradually increases (e.g., thereby enlarging and/or widening the flow path of the combustible gas-air mixture) along the length of the tube 104 beginning at the midpoint 152 of the venturi portion 144 and continuing to the beginning of the mixing portion 146 of the tube 104. In the illustrated example of FIGS. 1-11, the diameter of the circular cross-sectional area of the mixing portion 146 of the tube 104 is constant along the length of the mixing portion 146 of the tube 104. In other examples, the diameter of the circular cross-sectional area of the mixing portion 146 of the tube 104 can gradually taper in one direction or the other moving along the length of the mixing portion 146 of the tube 104.

The mixing portion 146 of the tube 104 of FIGS. 1-11 includes an example open rear end 608 located within the chamber 602 of the housing 102 and spaced forward of the rear wall 304 of the housing 102. The open rear end 608 of the mixing portion 146 of the tube 104 is preferably spaced forward of the rear wall 304 of the housing 102 by a distance that is greater than 5.0 millimeters and less than 20.0 millimeters. For example, in the illustrated example of FIGS. 1-9, the open rear end 608 of the mixing portion 146 of the tube 104 is spaced forward of the rear wall 304 of the housing 102 by a distance of approximately 7.5 millimeters. In other examples, the open rear end 608 of the mixing portion 146 of the tube 104 can instead be spaced forward of the rear wall 304 of the housing 102 by a distance that is less than 5.0 millimeters. In still other examples, the open rear end 608 of the mixing portion 146 of the tube 104 can instead be spaced forward of the rear wall 304 of the housing 102 by a distance that is greater than 20.0 millimeters.

The tube 104 of FIGS. 1-11 is configured to carry a combustible gas-air mixture from the inlet portion 142 of the tube 104 into and through the venturi portion 144 of the tube 104, and from the venturi portion 144 of the tube 104 into and through the mixing portion 146 of the tube 104. Upon exiting the open rear end 608 of the mixing portion 146 of the tube 104, the combustible gas-air mixture is directed (e.g., by the rear wall 304, the bottom wall 302, the top wall 110, the right sidewall 108, and the left sidewall 306 of the housing 102) forward within the chamber 602 of the housing 102 to respective ones of the first ports 114, to respective ones of the second ports 118, and/or to respective ones of the third port(s) 122 formed in the top wall 110 of the housing 102. Forcing the combustible gas-air mixture to travel the entire length of the mixing portion 146 of the tube 104 of the gas burner 100 before the combustible gas-air mixture is able to reach the first ports 114, the second ports 118, and/or the third port(s) 122 formed in the top wall 110 of the housing 102 of the gas burner 100 advantageously reduces the velocity of the combustible gas-air mixture, enables the gas and the air components that contribute to the combustible gas-air mixture to better mix with one another, and provides better control over the velocity of the combustible gas-air mixture at it reaches the first ports 114, the second ports 118, and/or the third port(s) 122.

In the illustrated example of FIGS. 1-9, an area of the mixing portion 146 of the tube 104 proximate the beginning (e.g., the front end) of the mixing portion 146 extends through the opening 112 formed in the front wall 106 of the housing 102 into the chamber 602 of the housing 102. In other examples, a larger portion (e.g., a greater longitudinal span) of the mixing portion 146 of the tube 104 can be located externally from the chamber 602 of the housing 102. As shown in FIGS. 6-9, the mixing portion 146 of the tube 104 is supported within the chamber 602 of the housing 102 by the support bracket 604 that is located within the chamber 602 of the housing 102. As further shown in FIGS. 6-9, the mixing portion 146 of the tube 104 includes an example contoured area 610 (e.g., a curved or arc-shaped area) that matches and/or complements the contoured portion 606 (e.g., a curved or arc-shaped portion) of the support bracket 604.

In the illustrated example of FIGS. 1-9, the mixing portion 146 and/or, more generally, the tube 104 is centrally positioned within the chamber 602 of the housing 102 between the first row 116 of the first ports 114 and the second row 120 of the second ports 118. In other examples, the mixing portion 146 and/or, more generally, the tube 104 can instead be skewed within the chamber 602 of the housing 102 closer to either the first row 116 of the first ports 114 or the second row 120 of the second ports 118. In the illustrated example of FIGS. 1-9, the mixing portion 146 and/or, more generally, the tube 104 is centrally positioned within the chamber 602 of the housing 102 between the right sidewall 108 and the left sidewall 306 of the housing 102. In other examples, the mixing portion 146 and/or, more generally, the tube 104 can instead be skewed within the chamber 602 of the housing 102 closer to either the right sidewall 108 or the left sidewall 306 of the housing 102. In the illustrated example of FIGS. 1-9, the mixing portion 146 and/or, more generally, the tube 104 is centrally positioned within the chamber 602 of the housing 102 between the bottom wall 302 and the top wall 110 of the housing 102. In other examples, the mixing portion 146 and/or, more generally, the tube 104 can instead be skewed within the chamber 602 of the housing 102 closer to either the bottom wall 302 or the top wall 110 of the housing 102.

The tube 104 of FIGS. 1-11 and/or, more generally, the gas burner 100 of FIGS. 1-9 further includes an example ignitor mounting bracket 154 configured to couple an ignitor to the tube 104 and/or, more generally, to the gas burner 100, as further described herein. In the illustrated example of FIGS. 1-11, the ignitor mounting bracket 154 is coupled to the tube 104 and located externally from the housing 102 at a position forward of the front wall 106 of the housing 102. As shown in FIGS. 1-9, the ignitor mounting bracket 154 extends upwardly from the tube 104, with the ignitor mounting bracket 154 being positioned directly over and/or above the venturi portion 144 of the tube 104.

The above-described gas burner 100 of FIGS. 1-9 advantageously produces and/or generates a maximum heat output that is preferably at least 16,000 BTU/hour. For example, in the illustrated example of FIGS. 1-9, the gas burner 100 produces and/or generates a maximum heat output of approximately 18,000 BTU/hour, which is significantly boosted (e.g., elevated and/or raised) relative to the maximum heat output that might otherwise be produced and/or generated by a conventional atmospheric gas burner of an equivalent size as the gas burner 100 (e.g., a burner tube having generally the same length and generally the same diameter as the tube 104 of the gas burner 100). The boosted maximum heat output (e.g., at least 16,000 BTU/hour) associated with the gas burner 100 of FIGS. 1-9 advantageously reduces preheating and/or cooking times associated with a gas-fueled outdoor cooking appliance implementing the gas burner 100, while also advantageously increasing the operational range and/or the turndown ratio associated with the gas burner 100 relative to the operational range and/or the turndown ratio associated with a conventional atmospheric gas burner of an equivalent size.

The gas burner 100 of FIGS. 1-9 advantageously facilitates such improvements with regard to the maximum heat output, the operational range, and the turndown ratio associated with the gas burner 100 while also advantageously minimizing (e.g., preventing) erratic flame behavior such as flashback, flame lift, and/or flame bunching. Such improvements arise as a result of spacing the open rear end 608 of the mixing portion 146 of the tube 104 of the gas burner 100 forward of the rear wall 304 of the housing 102 of the gas burner 100 by a preferred distance that is greater than 5.0 millimeters and less than 20.0 millimeters, and further as a result of spacing the second row 120 of the second ports 118 apart from the first row 116 of the first ports 114 formed in the top wall 110 of the housing 102 of the gas burner 100 by a preferred distance that is greater than 2.0 centimeters and less than 5.0 centimeters.

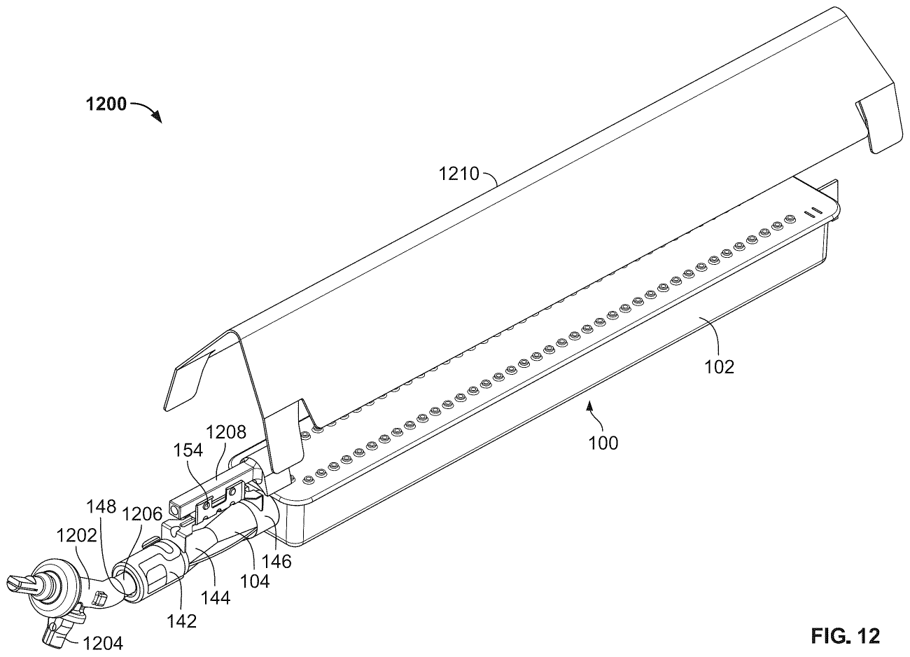

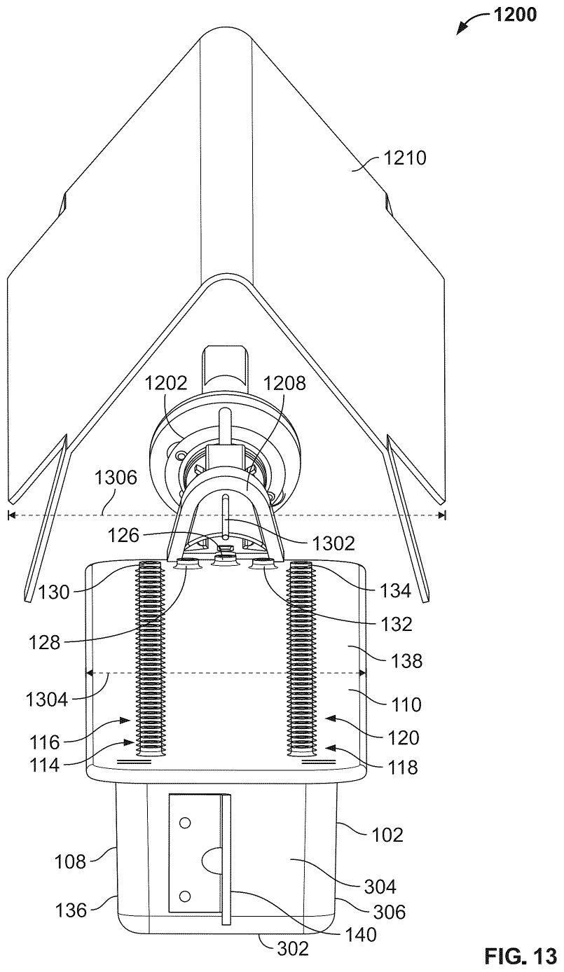

FIG. 12 is a perspective view of an example gas burner assembly 1200 constructed in accordance with the teachings of this disclosure. FIG. 13 is a rear perspective view of the gas burner assembly 1200 of FIG. 12. The gas burner assembly 1200 of FIGS. 12 and 13 includes the gas burner 100 of FIGS. 1-9 described above, including the housing 102 and the tube 104 thereof. In the illustrated example of FIGS. 12 and 13, the gas burner assembly 1200 further includes an example gas valve 1202 having an example inlet conduit 1204 and an example outlet nozzle 1206. The inlet conduit 1204 of the gas valve 1202 is configured to receive a flow of pressurized gas from a gas manifold to which the inlet conduit 1204 is operatively coupled, with the inlet conduit 1204 being in fluid communication with and located downstream from the gas manifold. The gas manifold is configured to receive pressurized gas from a gas source (e.g., a propane cylinder, a gas line, etc.), and to thereafter route and/or distribute the received pressurized gas to one or more gas valve(s) that is/are operatively coupled to (e.g., in fluid communication with) the gas manifold, with such valve(s) including the gas valve 1202 of FIGS. 12 and 13. The outlet nozzle 1206 of the gas valve 1202 of FIGS. 12 and 13 is configured to be inserted into and/or otherwise received by the open front end 148 of the inlet portion 142 of the tube 104 of the gas burner 100. The outlet nozzle 1206 of the gas valve 1202 is accordingly in fluid communication with the inlet portion 142 of the tube 104 of the gas burner 100 such that a flow of pressurized gas exiting the outlet nozzle 1206 of the gas valve 1202 enters into and/or travels through the inlet portion 142 of the tube 104 of the gas burner 100.

The gas valve 1202 of FIGS. 12 and 13 further includes a flow control member operatively positioned between the inlet conduit 1204 and the outlet nozzle 1206, with the flow control member being adjustable (e.g., rotatable to different positions) to regulate the rate at which the pressurized flow of gas exits the outlet nozzle 1206 of the gas valve 1202. In some examples, adjustment of the flow control member of the gas valve 1202 occurs in response to manual (e.g., human) interaction with a stem that is mechanically coupled to the flow control member. In other examples (e.g., when the gas valve 1202 is implemented as a solenoid valve), adjustment of the flow control member of the gas valve 1202 instead occurs in an automated manner based on one or more command(s) received at the gas valve 1202 from a controller that is operatively coupled to the gas valve 1202.

The gas burner assembly 1200 of FIGS. 12 and 13 further includes an example ignitor 1208 coupled to the ignitor mounting bracket 154 of the gas burner 100. The ignitor 1208 of FIGS. 12 and 13 is accordingly located externally from the housing 102 of the of the gas burner 100 proximate the front wall 106 of the housing 102. In the illustrated example of FIGS. 12 and 13, the ignitor 1208 includes an example ignition tip 1302 located proximate the third port(s) 122 (e.g., directly over and/or above the central port 126 of the third port(s)) 122) formed in the top wall 110 of the housing 102 of the gas burner 100. The ignition tip 1302 of the ignitor 1208 is configured to generate sparks that facilitate ignition of a combustible gas-air mixture as the combustible gas-air mixture exits the third port(s) 122 formed in the top wall 110 of the housing 102. In some examples, activation (e.g., firing or sparking) of the ignitor 1208 occurs in response to manual (e.g., human) interaction with an ignition button that is operatively coupled to the ignitor 1208. In other examples, activation (e.g., firing or sparking) of the ignitor 1208 can instead occur in an automated manner based on one or more command(s) received at the ignitor 1208 from a controller that is operatively coupled to the ignitor 1208.

The gas burner assembly 1200 of FIGS. 12 and 13 further includes an example grease deflection bar 1210 positioned over and/or above the top wall 110 of the housing 102 of the gas burner 100. In the illustrated example of FIGS. 12 and 13, the grease deflection bar 1210 has an inverted V-shaped cross-sectional profile extending along a length of the grease deflection bar 1210, with the inverted V-shaped profile including a peak that is oriented away from and centrally located above the top wall 110 of the housing 102 of the gas burner 100. As shown in FIG. 13, the top wall 110 of the housing 102 of the gas burner 100 has an example lateral width 1304. The grease deflection bar 1210 also has an example lateral width 1306. In the illustrated example of FIGS. 12 and 13, the lateral width 1306 of the grease deflection bar 1210 is greater than or equal to the lateral width 1304 of the top wall 110 of the housing 102 such that the grease deflection bar 1210 effectively covers the full lateral span of the top wall 110 of the housing 102. The aforementioned spatial relationship and/or arrangement between the grease deflection bar 1210 and the top wall 110 of the housing 102 advantageously prevents flammable liquid grease (e.g., as may be generated via one or more item(s) of food being cooked over and/or above the gas burner assembly 1200) from dripping onto the top wall 110 of the housing 102 and/or from dripping into any of the first ports 114, the second ports, 118, and/or the third port(s) 122 formed in the top wall 110 of the housing 102.

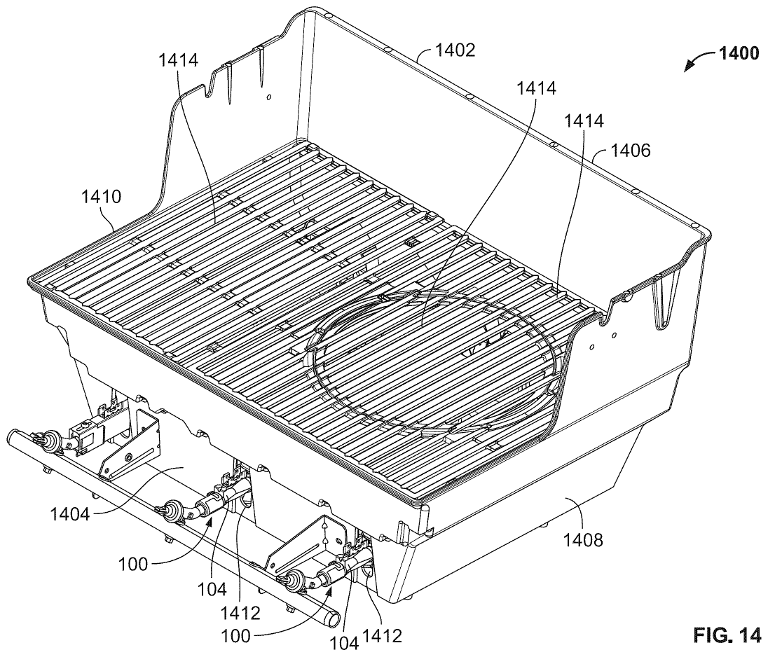

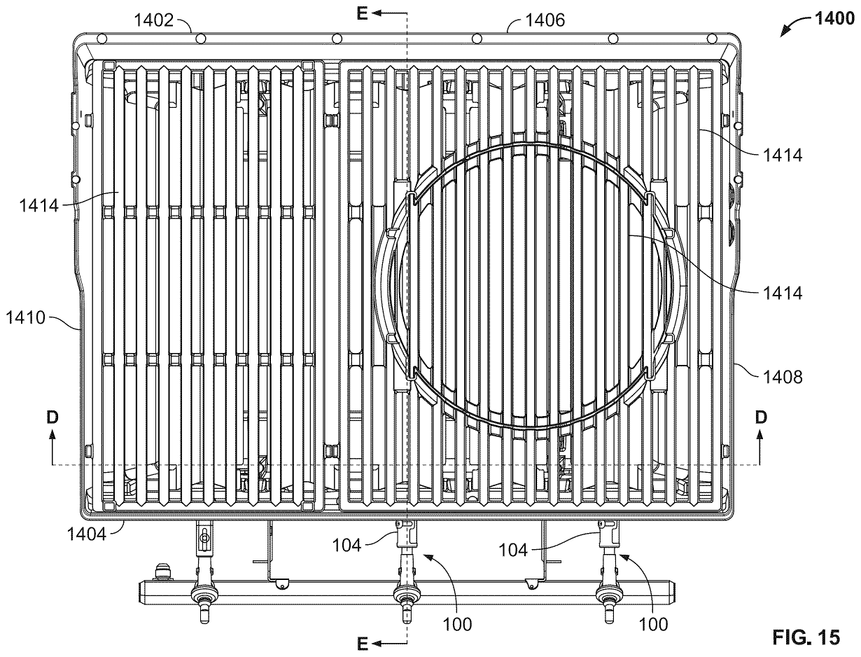

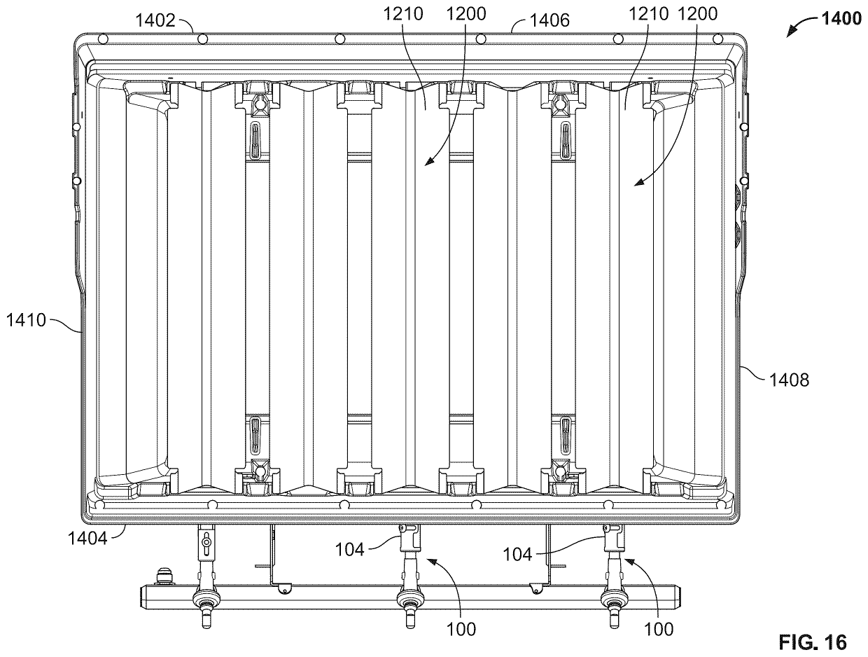

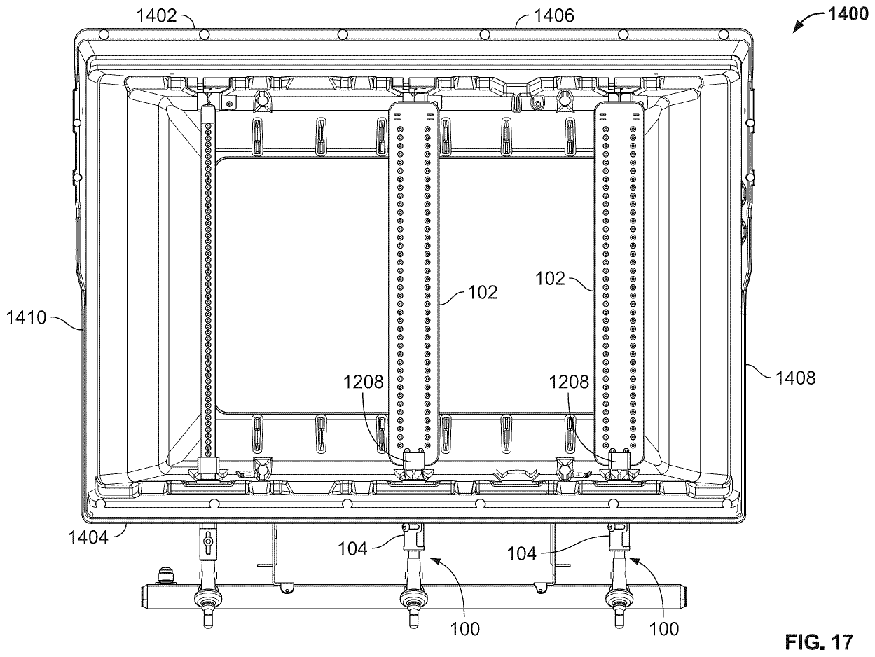

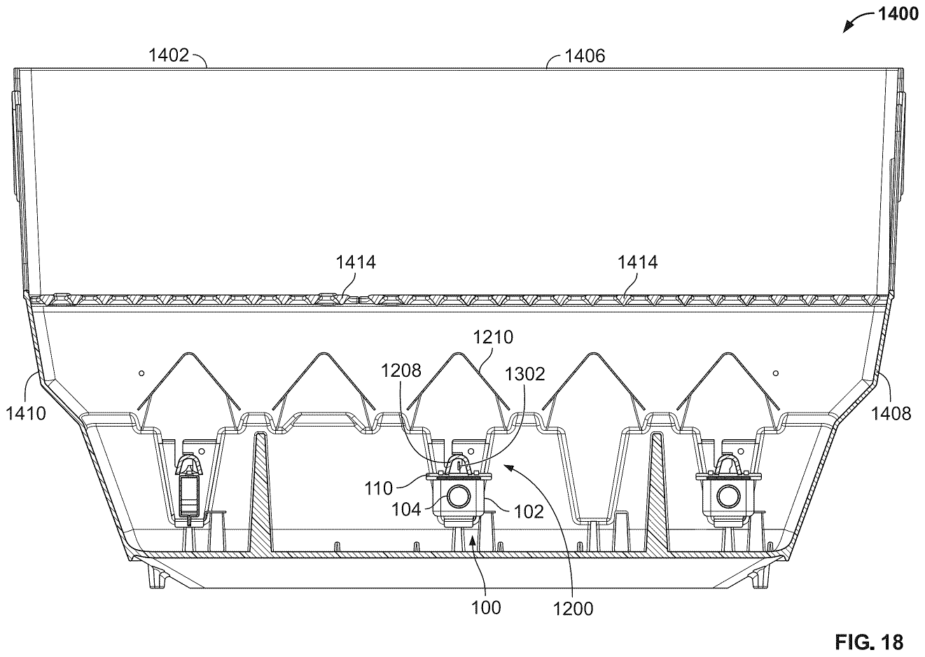

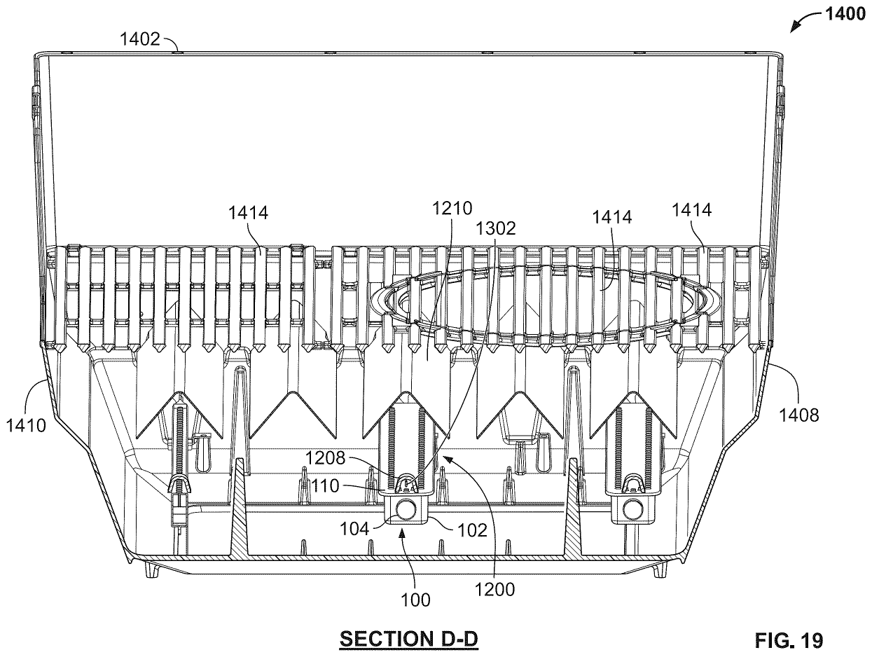

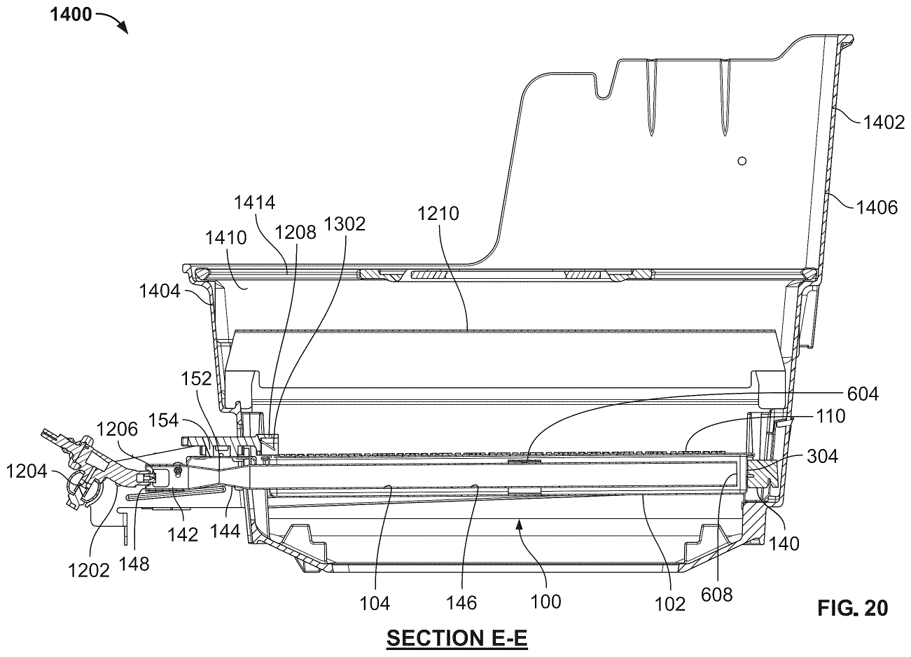

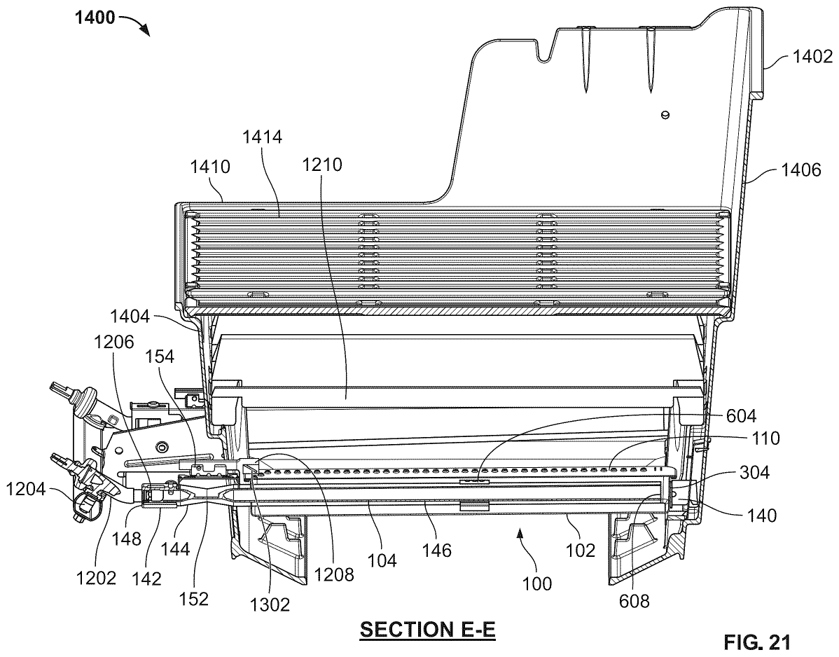

FIG. 14 is a perspective view of an example cookbox assembly 1400 including the gas burner assembly 1200 of FIGS. 12 and 13. FIG. 15 is a top view of the cookbox assembly 1400 of FIG. 14. FIG. 16 is a top view of the cookbox assembly 1400 of FIGS. 14 and 15, with the cooking grate(s) removed from the cookbox assembly 1400. FIG. 17 is a top view of the cookbox assembly 1400 of FIGS. 14-16, with the cooking grate(s) and the grease deflection bar(s) removed from the cookbox assembly 1400. FIG. 18 is a cross-sectional view of the cookbox assembly 1400 of FIGS. 14-17 taken along section D-D of FIG. 15. FIG. 19 is a perspective cross-sectional view of the cookbox assembly 1400 of FIGS. 14-18 taken along section D-D of FIG. 15. FIG. 20 is a cross-sectional view of the cookbox assembly 1400 of FIGS. 14-19 taken along section E-E of FIG. 15. FIG. 21 is a perspective cross-sectional view of the cookbox assembly 1400 of FIGS. 14-20 taken along section E-E of FIG. 15.

The cookbox assembly 1400 of FIGS. 14-21 includes the gas burner assembly 1200 of FIGS. 12 and 13 described above, which in turn includes the gas burner 100 of FIGS. 1-9 described above, including the housing 102 and the tube 104 thereof. In the illustrated example of FIGS. 14-21, the cookbox assembly 1400 includes two instances of the gas burner 100 of FIGS. 1-9 and one instance of a conventional atmospheric gas burner. In other examples, the cookbox assembly 1400 can instead include only a single instance of the gas burner 100 of FIGS. 1-9. In still other examples, each gas burner of the cookbox assembly 1400 can be implemented by an instance of the gas burner 100 of FIGS. 1-9.

The cookbox assembly 1400 of FIGS. 14-21 further includes an example cookbox 1402 that houses, carries, supports, and/or otherwise includes a substantial portion of the gas burner assembly 1200 of FIGS. 12 and 13. For example, as shown in FIGS. 14-21, the entirety of the housing 102 and at least a portion (e.g., at least the mixing portion 146) of the tube 104 of the gas burner 100 are located within the cookbox 1402. The entirety of the grease deflection bar 1210 is also located within the cookbox 1402. As shown in FIGS. 14-21, the gas burner 100 and the grease deflection bar 1210 are respectively arranged in a front-to-rear orientation relative to the cookbox 1402. In this regard, the cookbox 1402 includes an example front wall 1404, an example rear wall 1406 spaced apart from the front wall 1404, an example right sidewall 1408 extending between the front wall 1404 and the rear wall 1406, and an example left sidewall 1410 spaced apart from the right sidewall 1408 and extending between the front wall 1404 and the rear wall 1406. The gas burner 100 and the grease deflection bar 1210 are respectively arranged in a direction extending between the front wall 1404 and the rear wall 1406 of the cookbox 1402. In the illustrated example of FIGS. 14-21, the mounting flange 140 of the gas burner 100 couples the housing 102 of the gas burner 100 to the rear wall 1406 of the cookbox 1402. The front wall 1404 of the cookbox 1402 includes an example opening 1412 configured to receive a portion (e.g., the venturi portion 144 or the mixing portion 146) of the tube 104 of the gas burner 100 of the gas burner assembly 1200.

The cookbox 1402 of FIGS. 14-21 also houses, carries, supports, and/or otherwise includes one or more example cooking grate(s) 1414 located and/or positioned within the cookbox 1402 above the grease deflection bar 1210. The cooking grate(s) 1414 is/are configured to form and/or define a substantially flat, planar cooking surface for cooking one or more food item(s) placed thereon. As shown in FIGS. 14-21, the cooking grate(s) 1414 is/are configured to fill, cover, and/or occupy the substantial entirety of the horizontal form factor and/or footprint of the cookbox 1402 (e.g., as defined by the width and the depth of the cookbox 1402). In other examples, the cooking grate(s) 1414 can instead be configured to fill, cover, and/or occupy a relatively smaller portion and/or percentage (e.g., less than the substantial entirety) of the horizontal form factor and/or footprint of the cookbox 1402. Combustible liquid grease that drips downward from the cooking grate(s) 1414 as one or more item(s) of food are cooked thereon is deflected away from respective ones of the first ports 114, the second ports 118, and/or the third port(s) 122 formed in the top wall 110 of the housing 102 of the gas burner 100 via the grease deflection bar 1210, thereby preventing such grease from dripping onto and/or entering into such ports.

From the foregoing, it will be appreciated that the disclosed boosted output gas burners provide significant improvements with regard to the maximum heat output, the operational range, and the associated turndown ratio that are attainable from such boosted output gas burners relative to the maximum heat output, the operational range, and the associated turndown ratio that are attainable via conventional atmospheric gas burners of an equivalent size. Such improvements provide numerous advantages to gas-fueled outdoor cooking appliances and the user experience associated therewith. The disclosed boosted output gas burners advantageously facilitate such improvements while also advantageously minimizing (e.g., preventing) erratic flame behavior such as flashback, flame lift, and/or flame bunching. Furthermore, forcing the combustible gas-air mixture to travel the entire length of the mixing portion of the tube before the combustible gas-air mixture is able to reach the first ports and/or the second ports formed in the top wall of the housing advantageously reduces the velocity of the combustible gas-air mixture, enables the gas and the air components that contribute to the combustible gas-air mixture to better mix with one another, and provides better control over the velocity of the combustible gas-air mixture at it reaches the first ports and the second ports.

The following paragraphs provide various examples in relation to the disclosed boosted output gas burners for gas-fueled outdoor cooking appliances.

Example 1 includes a gas burner for use with a gas-fueled outdoor cooking appliance. In Example 1, the gas burner comprises a housing and a tube. The housing includes a bottom wall, a front wall, a rear wall, a right sidewall, a left sidewall, and a top wall. The front wall includes an opening. The top wall includes a plurality of first ports arranged in a first row and a plurality of second ports arranged in a second row spaced apart from the first row. The tube is located at least partially within the housing. The tube extends through the opening of the front wall of the housing. The tube includes an inlet portion, a venturi portion in fluid communication with and located downstream from the inlet portion, and a mixing portion in fluid communication with and located downstream from the venturi portion. The inlet portion includes an open front end located externally from the housing. The mixing portion including an open rear end located within the housing and spaced forward of the rear wall of the housing. The tube is configured to carry a combustible gas-air mixture from the inlet portion into and through the venturi portion and from the venturi portion into and through the mixing portion. Upon exiting the open rear end of the mixing portion, the combustible gas-air mixture is directed forward within the housing to respective ones of the first ports and respective ones of the second ports.

Example 2 includes the gas burner of Example 1. In Example 2, the inlet portion of the tube is located externally from the housing.

Example 3 includes the gas burner of Example 1. In Example 3, the venturi portion of the tube is located externally from the housing.

Example 4 includes the gas burner of Example 1. In Example 4, the open rear end of the mixing portion of the tube is spaced forward of the rear wall of the housing by a distance that is greater than 5.0 millimeters and less than 20.0 millimeters.

Example 5 includes the gas burner of Example 1. In Example 5, the gas burner further comprises an ignitor mounting bracket coupled to the tube and located externally from the housing.

Example 6 includes the gas burner of Example 5. In Example 6, the ignitor mounting bracket is positioned over the venturi portion of the tube.

Example 7 includes the gas burner of Example 1. In Example 7, the tube is centrally positioned within the housing between the first row of the first ports and the second row of the second ports.

Example 8 includes the gas burner of Example 1. In Example 8, the second row of the second ports is parallel to the first row of the first ports.

Example 9 includes the gas burner of Example 8. In Example 9, the second row of the second ports is spaced apart from the first row of the first ports by a distance that is greater than 2.0 centimeters and less than 5.0 centimeters.

Example 10 includes the gas burner of Example 1. In Example 10, the top wall of the housing further includes at least one third port located proximate the front wall of the housing between the first row of the first ports and the second row of the second ports. The at least one third port is configured to facilitate ignition of the combustible gas-air mixture via an ignitor located externally from the housing proximate the at least one third port, and to facilitate spreading the ignition of the combustible gas-air mixture to the first ports and the second ports.

Example 11 includes the gas burner of Example 10. In Example 11, the at least one third port is configured as three or more ports arranged in a V-shaped formation including a central port, at least one first branch port located between the central port and a front one of the first ports of the first row, and at least one second branch port located between the central port and a front one of the second ports of the second row.

Example 12 includes the gas burner of Example 1. In Example 12, the front wall extends upwardly from the bottom wall, the rear wall is spaced apart from the front wall, the rear wall extends upwardly from the bottom wall, the right sidewall extends upwardly from the bottom wall, the right sidewall extends between the front wall and the rear wall, the left sidewall is spaced apart from the right sidewall, the left sidewall extends upwardly from the bottom wall, the left sidewall extends between the front wall and the rear wall, the top wall is spaced apart from the bottom wall, and the top wall extends between the front wall and the rear wall and between the right sidewall and the left sidewall.

Example 13 includes the gas burner of Example 12. In Example 13, the front wall, the rear wall, the right sidewall, and the left sidewall are integrally formed with the bottom wall to provide a base. The top wall provides a cover for the base. The cover is coupled to the base.

Example 14 includes the gas burner of Example 1. In Example 14, the gas burner further comprises a support bracket located within the housing between the front wall and the rear wall. The support bracket supports the mixing portion of the tube within the housing.

Example 15 includes the gas burner of Example 14. In Example 15, the support bracket is coupled to and extends upwardly from the bottom wall of the housing.

Example 16 includes the gas burner of Example 1. In Example 16, the open front end of the inlet portion of the tube is configured to receive a nozzle of a gas valve.

Example 17 includes the gas burner of Example 1. In Example 17, the gas burner further comprises an air shutter coupled to the inlet portion of the tube.

Example 18 includes the gas burner of Example 1. In Example 18, the gas burner further comprises a mounting flange coupled to and extending rearwardly from the rear wall of the housing.

Example 19 includes a gas burner assembly for use with a gas-fueled outdoor cooking appliance. In Example 19, the gas burner assembly comprises a gas burner and a grease deflection bar. The gas burner includes a housing and a tube. The housing includes a bottom wall, a front wall, a rear wall, a right sidewall, a left sidewall, and a top wall. The front wall includes an opening. The top wall includes a plurality of first ports arranged in a first row and a plurality of second ports arranged in a second row spaced apart from the first row. The tube is located at least partially within the housing. The tube extends through the opening of the front wall of the housing. The tube includes an inlet portion, a venturi portion in fluid communication with and located downstream from the inlet portion, and a mixing portion in fluid communication with and located downstream from the venturi portion. The inlet portion includes an open front end located externally from the housing. The mixing portion includes an open rear end located within the housing and spaced forward of the rear wall of the housing. The tube is configured to carry a combustible gas-air mixture from the inlet portion into and through the venturi portion and from the venturi portion into and through the mixing portion. Upon exiting the open rear end of the mixing portion, the combustible gas-air mixture is directed forward within the housing to respective ones of the first ports and respective ones of the second ports. The grease deflection bar is positioned over the gas burner. The grease deflection bar has a lateral width that is greater than or equal to a lateral width of the top wall of the housing.

Example 20 includes the gas burner assembly of Example 19. In Example 20, the second row of the second ports is parallel to the first row of the first ports. The second row of the second ports is spaced apart from the first row of the first ports by a distance that is greater than 2.0 centimeters and less than 5.0 centimeters.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A gas burner for use with a gas-fueled outdoor cooking appliance, the gas burner comprising:
a housing including a bottom wall, a front wall, a rear wall, a right sidewall, a left sidewall, and a top wall, the front wall including an opening, the top wall including a plurality of first ports arranged in a first row and a plurality of second ports arranged in a second row spaced apart from the first row; and
a tube located at least partially within the housing, the tube extending through the opening of the front wall of the housing, the tube including an inlet portion, a venturi portion in fluid communication with and located downstream from the inlet portion, and a mixing portion in fluid communication with and located downstream from the venturi portion, the inlet portion including an open front end located externally from the housing, the mixing portion including an open rear end located within the housing and spaced forward of the rear wall of the housing, wherein the tube is configured to carry a combustible gas-air mixture from the inlet portion into and through the venturi portion and from the venturi portion into and through the mixing portion, wherein upon exiting the open rear end of the mixing portion, the combustible gas-air mixture is directed forward within the housing to respective ones of the first ports and respective ones of the second ports.

2. The gas burner of claim 1, wherein the inlet portion of the tube is located externally from the housing.

3. The gas burner of claim 1, wherein the venturi portion of the tube is located externally from the housing.

4. The gas burner of claim 1, wherein the open rear end of the mixing portion of the tube is spaced forward of the rear wall of the housing by a distance that is greater than 5.0 millimeters and less than 20.0 millimeters.

5. The gas burner of claim 1, further comprising an ignitor mounting bracket coupled to the tube and located externally from the housing.

6. The gas burner of claim 5, wherein the ignitor mounting bracket is positioned over the venturi portion of the tube.

7. The gas burner of claim 1, wherein the tube is centrally positioned within the housing between the first row of the first ports and the second row of the second ports.

8. The gas burner of claim 1, wherein the second row of the second ports is parallel to the first row of the first ports.

9. The gas burner of claim 8, wherein the second row of the second ports is spaced apart from the first row of the first ports by a distance that is greater than 2.0 centimeters and less than 5.0 centimeters.

10. The gas burner of claim 1, wherein the top wall of the housing further includes at least one third port located proximate the front wall of the housing between the first row of the first ports and the second row of the second ports, wherein the at least one third port is configured to facilitate ignition of the combustible gas-air mixture via an ignitor located externally from the housing proximate the at least one third port, and to facilitate spreading the ignition of the combustible gas-air mixture to the first ports and the second ports.

11. The gas burner of claim 10, wherein the at least one third port is configured as three or more ports arranged in a V-shaped formation including a central port, at least one first branch port located between the central port and a front one of the first ports of the first row, and at least one second branch port located between the central port and a front one of the second ports of the second row.

12. The gas burner of claim 1, wherein the front wall extends upwardly from the bottom wall, the rear wall is spaced apart from the front wall, the rear wall extends upwardly from the bottom wall, the right sidewall extends upwardly from the bottom wall, the right sidewall extends between the front wall and the rear wall, the left sidewall is spaced apart from the right sidewall, the left sidewall extends upwardly from the bottom wall, the left sidewall extends between the front wall and the rear wall, the top wall is spaced apart from the bottom wall, and the top wall extends between the front wall and the rear wall and between the right sidewall and the left sidewall.

13. The gas burner of claim 12, wherein the front wall, the rear wall, the right sidewall, and the left sidewall are integrally formed with the bottom wall to provide a base, wherein the top wall provides a cover for the base, and wherein the cover is coupled to the base.

14. The gas burner of claim 1, further comprising a support bracket located within the housing between the front wall and the rear wall, wherein the support bracket supports the mixing portion of the tube within the housing.

15. The gas burner of claim 14, wherein the support bracket is coupled to and extends upwardly from the bottom wall of the housing.

16. The gas burner of claim 1, wherein the open front end of the inlet portion of the tube is configured to receive a nozzle of a gas valve.

17. The gas burner of claim 1, further comprising an air shutter coupled to the inlet portion of the tube.

18. The gas burner of claim 1, further comprising a mounting flange coupled to and extending rearwardly from the rear wall of the housing.

19. A gas burner assembly for use with a gas-fueled outdoor cooking appliance, the gas burner assembly comprising:
a gas burner including:
a housing including a bottom wall, a front wall, a rear wall, a right sidewall, a left sidewall, and a top wall, the front wall including an opening, the top wall including a plurality of first ports arranged in a first row and a plurality of second ports arranged in a second row spaced apart from the first row; and
a tube located at least partially within the housing, the tube extending through the opening of the front wall of the housing, the tube including an inlet portion, a venturi portion in fluid communication with and located downstream from the inlet portion, and a mixing portion in fluid communication with and located downstream from the venturi portion, the inlet portion including an open front end located externally from the housing, the mixing portion including an open rear end located within the housing and spaced forward of the rear wall of the housing, wherein the tube is configured to carry a combustible gas-air mixture from the inlet portion into and through the venturi portion and from the venturi portion into and through the mixing portion, wherein upon exiting the open rear end of the mixing portion, the combustible gas-air mixture is directed forward within the housing to respective ones of the first ports and respective ones of the second ports; and
a grease deflection bar positioned over the gas burner, the grease deflection bar having a lateral width that is greater than or equal to a lateral width of the top wall of the housing.

20. The gas burner assembly of claim 19, wherein the second row of the second ports is parallel to the first row of the first ports, wherein the second row of the second ports is spaced apart from the first row of the first ports by a distance that is greater than 2.0 centimeters and less than 5.0 centimeters.
